(19) United States
(12) Patent Application Publication
(10) Pub. No.: US 2009/0247917 A1
(43) Pub. Date: Oct. 1, 2009

(54) MASSAGING DEVICE

(76) Inventor: Dong Rae Park, Dallas, TX (US)

Correspondence Address: CARSTENS & CAHOON, LLP, P O BOX 802334, DALLAS, TX, 75380, US

(21) Appl. No.: 12/055,226

(22) Filed: Mar. 25, 2008

(51) Int. Cl. A61H 7/00

(52) U.S. Cl. 601/99; 601/98

(57) ABSTRACT

An improved massaging apparatus composed of a table for holding a patient that contains a movable portion and provides reciprocating motion. The apparatus of the present invention provides an improved massaging device that allows for the strengthening and relaxation of the back through the simultaneous decompression of the spine and stretching of the muscles that surround the spine. A specialized massage table contains a movable component on which a user will place his or her buttocks. The movable component shifts back and forth longitudinally in a substantially horizontal plane to expand and compress the spine, such that fluid may flow through the intervertebral discs in between the vertebrae and provide lubrication, enabling more comfortable and flexible movement of the spine and its surrounding muscles as well as maintaining the organs associated with the spine in good physical shape.

### BACKGROUND OF THE INVENTION

1. Technical Field

The present invention relates to an improved method for massaging the back such that the spine decompresses to relieve the strain imposed on the backbone, its surrounding muscles, and its interconnected structures by everyday activities.

2. Description of Related Art

Back pain is a common problem for most people. Ordinary activities such as sitting, standing, lifting, walking, twisting, sleeping, and even napping on a couch or the lack of movement on a road trip will eventually take their toll on the human back. About nine out of ten adults experience back pain at some point in their life, and five out of ten working adults have back pain every year. This pain can stem from any number of the interconnected muscles, nerves, bones, joints, tissues, tendons, or other structures of the spine, also known as the backbone. The most common back pains actually occur due to poor posture and weakened muscles resulting from weakened parts of the spine.

Routine massages help relax the back muscles that surround the spine and may also alter chronic tension by the release of restrictions within the fascia surrounding the muscle and toxins within the body, but do not provide means for decompressing the spine to relieve added stress in between the vertebrae. As seen in FIG. 1a, the vertebrae do not form a straight and rigid structure. Rather, these regions form four spinal curves when properly aligned. The spine is made up of 33 vertebrae, subdivided by vertebral structure, consisting of seven cervical vertebrae 110, twelve thoracic vertebrae 120, five lumbar vertebrae 130, five fused sacral vertebrae 140, and four fused coccygeal vertebrae, commonly known as the tailbone 150. FIG. 2 illustrates a close-up of the thoracic portion of the spine to emphasize the intervertebral discs 210, which lie between the vertebrae 220 to act as shock absorbers, compressing and distorting when stressed by any number of movements and preventing bone-to-bone contact that might damage the vertebrae. FIG. 3 shows further details of a typical anatomy of the vertebra. Ligaments (not shown), made of fibrous material and containing pain sensors, tie the vertebrae together; while the spinal cord 430 is threaded through the center of the spine. Nerves 410 branch of from the spinal cord 430 and exit from the openings between each vertebra to communicate with specific organs and parts of the body. Nerve irritations from spinal misalignment are often felt throughout the body not only in the form of back pain, but also in the form of heartburn, insomnia, lowered immune function, or sciatica; even hemorrhoids commonly result from poor posture and incorrect lifting or bending.

Orthopedic mattresses proclaim a means for giving the spine correct support with minimal distortion, alleviating back pain and the morning stiffness that comes with age, but only ease the pressures at night. Pillows, such as sleeping pillows and contour memory foam pillows, are also said to help keep the backbone in alignment as you sleep or lie down but do not provide relief from other everyday movements. Further, fluid flows into the intervertebral discs of the spine during sleep, but is not pushed out, filling the discs to their maximum and making them stiff. Because of this, spines tend to be stiffer in the morning and less able to bend. Lumbar support pillows are said to support the back and lumbar region while sitting and back pillows or specialized chairs also promote proper posture to help relieve the strain on intervertebral discs or necks. However, these do not reverse the strain on the spine that comes from walking, running, lifting, or any other common movements that make life more enjoyable.

The spine provides the basic structure for both muscles and skeletal bones, such as the shoulders, ribcage, and pelvis, defining height and providing support for the head and upper body. Further, it houses and protects the spinal cord, which plays a major role in the central nervous system, sending countless messages between the brain and the body and providing conscious movement of the muscles. Finally, the unique interlocking joint structure of the spinous processes and the flexible discs provides the body with a great deal of flexibility and mobility to move forward and backward without affecting the integrity of the spinal cord. The loss in height that comes with age results from the decreasing size and resiliency of these discs, as they naturally wear out over time; but poor posture can increase the speed of degradation. In addition, the daily stress placed on the discs and vertebrae will ultimately lead to inflammation and discomfort. When inflamed, the spine is weakened and the muscles surrounding the spine tighten to support it. The tightening of the muscles may lead to the muscles going into spasm adding additional pain and discomfort. Massages will alleviate the tightened muscles but do not provide enough relief to the compressed spine, which is the root of the problem. In addition, there are some people who cannot benefit from massages due to long-term injury or a general preference against it. The muscles connected to the back are also connected to the lymphatic system, making it possible to release some of the toxins of the body without massaging techniques.

Consequently, there is a need for an improved massaging apparatus that will allow for decompression and elongation of the spine as well as relaxation of the back muscles and release of toxins from the body. Further, there is a need for such apparatus to fight the pressures of gravity without any harmful side effects to the body or joints that are involved in some forms of exercise. Finally, it is desirable to realize the effects of such apparatus throughout all the natural curvature regions of the back, while providing means for targeting specific vertebrae in the back, such that the entire body and its organs are revitalized.

### SUMMARY OF THE INVENTION

The present invention provides an apparatus that gently strengthens and relaxes the back through the simultaneous decompression of the spine and extension of the muscles that surround the spine. In a preferred embodiment, a specialized massage table contains an adjustable positioning pad, on which a user will place his or her pelvis, and a reciprocating device, which applies a translational force to the user's spine. In one embodiment, a user places his or her hands over his or her head to hold onto handles as the movable component shifts back and forth longitudinally in a substantially horizontal plane. In another embodiment, a user places his feet through a bar as the movable component shifts back and forth in the same manner. The position of the user's body may further be varied to lie face up, face down, or on either side. The movement allows for the expansion and compression of the spine, such that fluid may flow through the intervertebral disc and provide nourishment and lubrication, enabling more comfortable and flexible movement of the spine and providing strength and endurance to the surrounding muscles. Further, the organs, nerves, and joints associated with the spine as well as the lymphatic system, which is connected to the muscular system, are also strengthened and maintained in good physical shape. Optionally, a remote control for the apparatus is attached to the table such that a user can manually operate the massaging device without the aid of another party to control the speed and timing of the movement.

Other aspects, embodiments and features of the invention will become apparent from the following detailed description of the invention when considered in conjunction with the accompanying drawings. The accompanying figures are schematic and are not intended to be drawn to scale. In the figures, each identical, or substantially similar, component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1a depicts a profile lateral view of the vertebral column, showing the natural spinal curvatures.

FIG. 1b illustrates a detailed view of a typical vertebra.

FIG. 2 depicts a close-up lateral view of the thoracic region of the spinal column with its intervertebral discs.

FIG. 3a depicts a cross-sectional view of the typical anatomy of a compressed vertebra and the structure of the intervertebral articulations.

FIG. 3b illustrates a cross-sectional view of the anatomy of a typical de-compressed vertebra.

FIG. 4 is a perspective top view of the massage table of the present invention.

FIG. 5 illustrates a close-up view of the adjustable positioning pad on the massage table of the present invention.

FIG. 6 illustrates a close-up view of the reciprocating motion device on the massage table of the present invention.

FIG. 7a illustrates the effects of the adjustable seat of the present invention along specific vertebrae when in motion.

FIG. 7b illustrates a general close-up view of the different vertebrae that may be targeted using the present invention.

FIG. 8a depicts a user face up on the massage table of the present invention in one preferred embodiment of the present invention.

FIG. 8b depicts a user lying on his side on the massage table of the present invention in a second preferred embodiment.

FIG. 8c depicts a user lying face down on the massage table of the present invention in a third preferred embodiment.

FIG. 8d depicts a user lying face up in the opposite direction on the massage table of the present invention in a fourth preferred embodiment.

FIG. 9 depicts the control system of the present invention in a preferred embodiment.

### DETAILED DESCRIPTION

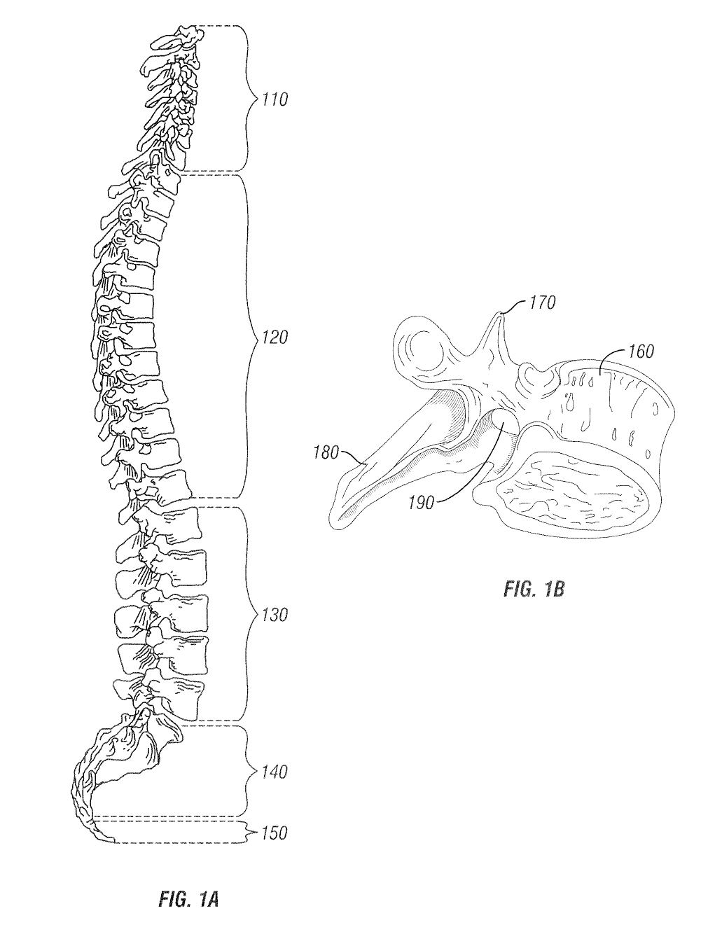

Using the apparatus of the present invention, a user will lie horizontally to feel the effects of an improved massaging technique, which decompresses the spine and relaxes the muscles in the body, while providing means for lymph movement to detoxify the body. As previously disclosed, FIG. 1a demonstrates the natural formation of the spine when standing with correct posture. The thoracic 120 and sacral curves 140 are known as the accommodation curves because they accommodate the thoracic and abdominopelvic viscera, while the lumbar 130 and cervical 110 curves are known as the compensation curves because they help position the body weight over the legs. Positioned properly, the weight of the body is evenly distributed along the backbone, placing less stress on the vertebrae and providing resistance and elasticity in distributing body weight and axial loads sustained during movement. FIG. 1b illustrates a close-up of a typical vertebra. The spinal process 180 is the site for attachment of many spinal muscles and often is mistaken for the whole backbone as it is the only part of the spine that can be touched with the hands. However, as evident by FIG. 1b, the vertebrae of the spine are more complex than what can be stroked or kneaded with the hands during a massage. The mass of a vertebra is concentrated within the body, or centrum, 160 and successive vertebrae attached at gliding joints between superior articular processes 170 and inferior articular processes (not shown). The superior articular processes function to limit rotation, which can take place in the lumbar segment of the vertebral column during any asymmetrical movement of the body. For illustrative purposes of one of the roles the spine plays, the vertebral foramen 190 forms an open space that houses the spinal cord.

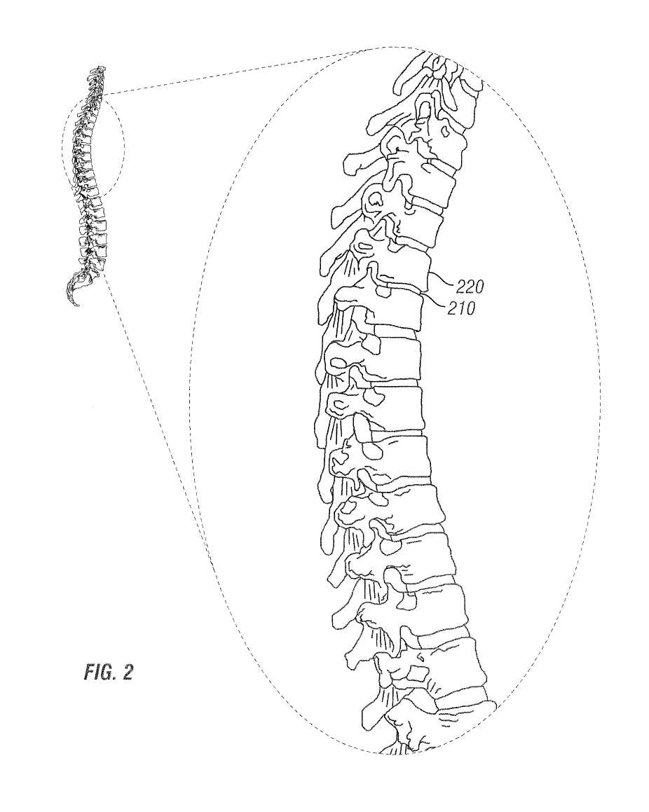

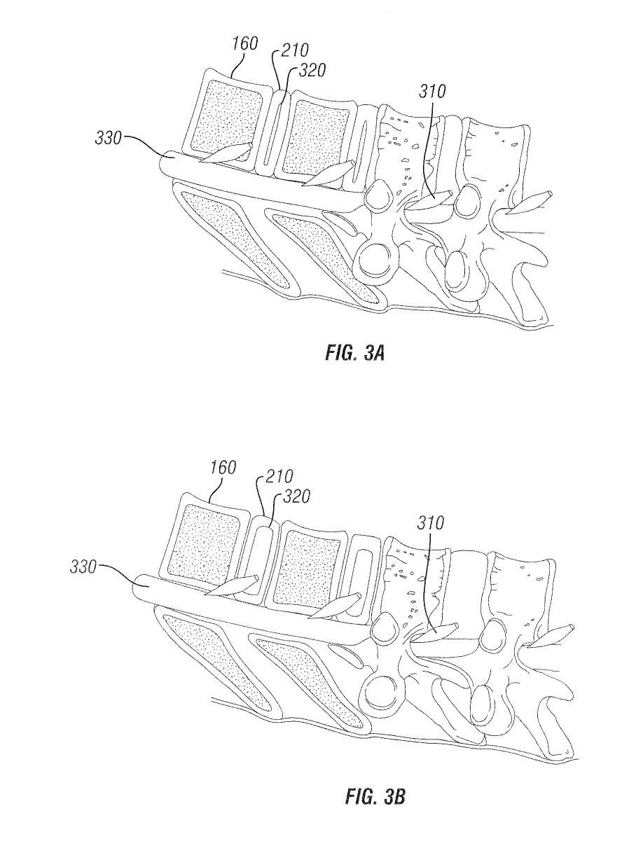

FIG. 2 illustrates a lateral close-up view of the thoracic region of the spinal column with its intervertebral discs, 210. The thoracic region composes the middle segment of the spine. Each of the twelve thoracic vertebrae 220 articulates with the ribs of the rib cage (not shown). The location and structure of the individual vertebra vary as indicated by FIG. 2, but the typical structure of the spine and its intervertebral articulations is depicted in FIG. 3a. The intervertebral discs 210 actually make up one fourth of the spine's length. (There are no intervertebral discs between the first and second cervical vertebrae, nor are they found between the sacral or coccygeal vertebrae but they still play an important role in holding up the weight of the body.)

The intervertebral discs 210 consist of an extensive region of fibrocartilage, known as annulus fibrosus, connected to the vertebral end plates and enclosing a soft, elastic and gelatinous nucleus pulposus 320 that resists compression. Because these discs 210 are not vascular, they depend on diffusion to receive the nutrients needed to perform the extension and flexion (ie, movement) of the spine. Further, the disc 210 is composed of water, collagen and proteoglycans, which attract and retain water. Most of the fluid in the form of water and proteoglycans resides in the nucleus pulposus 320, providing nourishment and lubrication to the disc 210 to enable the forward and backward movement of the vertebrae, which allows the human body to bend. The amount of fluid will vary through the day depending on daily activities and by the end of day, there will likely be less fluid in the discs, forcing them to become compacted, as seen in FIG. 3a. As a result, the discs 210 narrow as the cushion is lessoned and the vertebrae will lie closer together, increasing the risk of irritation and back pain as the vertebrae are more likely to make aching contact.

Using the present invention, the discs 210 of the spine are filled with fluids to allow for de-compression as seen in FIG. 3b. Because the spine is interconnected to spinal muscles (at its spinal process 180), multiples nerves 310, and the spinal cord 330, de-compression will simultaneously massage and stimulate both the muscles and organs of the body. In addition to fighting the negative effects that gravity has on the spine, de-compression will also alleviate back pains and aches and elongate the torso.

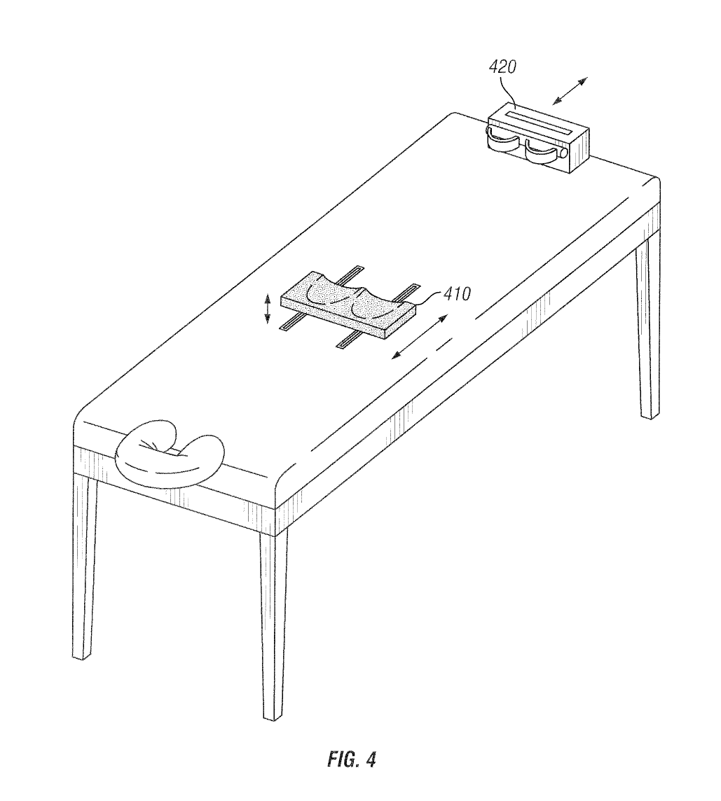

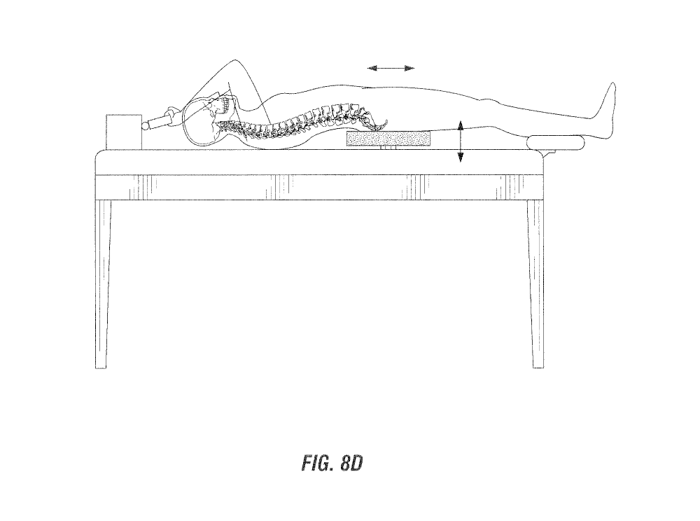

FIG. 4 depicts the massage table for holding a patient of the present invention with a positioning pad 410 capable of adjustably shifting both vertically as well as longitudinally and parallel with the spine. In a preferred embodiment, the reciprocating motion device 420 will move between ¾ of an inch to approximately 1½ inches towards and away from the patient's body, at least three times per second. The positioning pad 410 is specially contoured to adapt to the shape of a person's buttocks or pelvis and comfortably maintain the patient's pelvis and lower torso in place. As used herein, a reciprocating motion device 420 is a device located at one end of the table that simultaneously moves in a forward and backward motion, which repeats over and over again at a suitable speed so as to allow decompression of the spine and stretch any tightened muscles connected to the spine. In a preferred embodiment, the reciprocator 420 contains foot stirrups such that the user may either lie with his or her feet on the reciprocator 420, as seen in FIG. 8a, or with his head by the reciprocator 420, as seen in FIG. 8d. By placing one's hands in the hand grips, or feet within the stirrups, of the reciprocator 420 and use of a positioning pad capable of adjustment vertically or horizontally, additional support is achieved as the reciprocating motion device shifts back and forth, compressing and expanding the spine to allow for the right amount of fluids to enter and exit the discs of the spine. Optionally, the table contains a remote control so that a user can operate the table without the aid of another party.

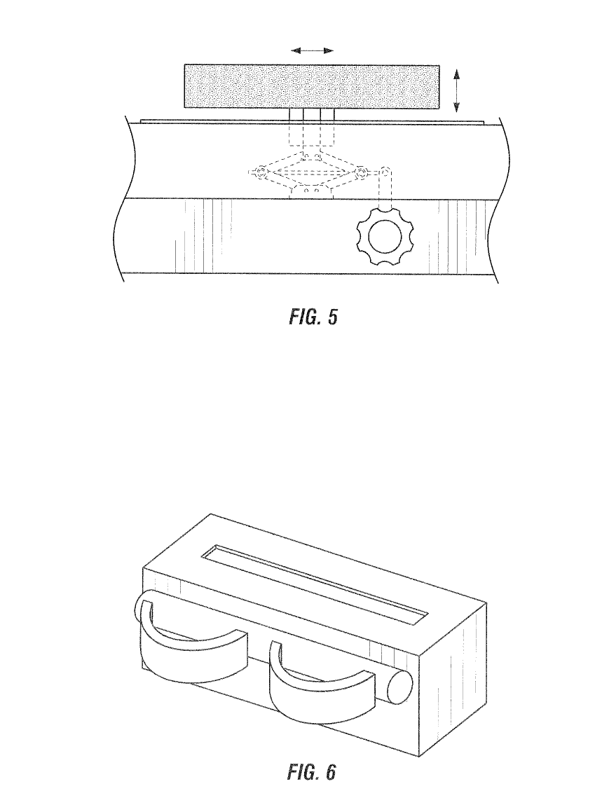

FIG. 5 depicts a close-up detailed view of the adjustable positioning pad 410 of the present invention. As previously disclosed, a user lies horizontally with his pelvis on top of the pad 410, which lies in the middle of two tracks, rails, or slits within the cushioned massage table, such that the cushion may be adjusted horizontally to adapt to a user's height. In another preferred embodiment, the cushion is also capable of adjusting vertically in order to target different vertebrae along the spine. The manner of adjustment is not specific; adjustment is achieved by any means known in the art. In one preferred embodiment, the seat is adjusted manually such as with a scissor jack, for example, as depicted in FIG. 5; however, automatic adjustment is also possible in another embodiment such as by electric controls.

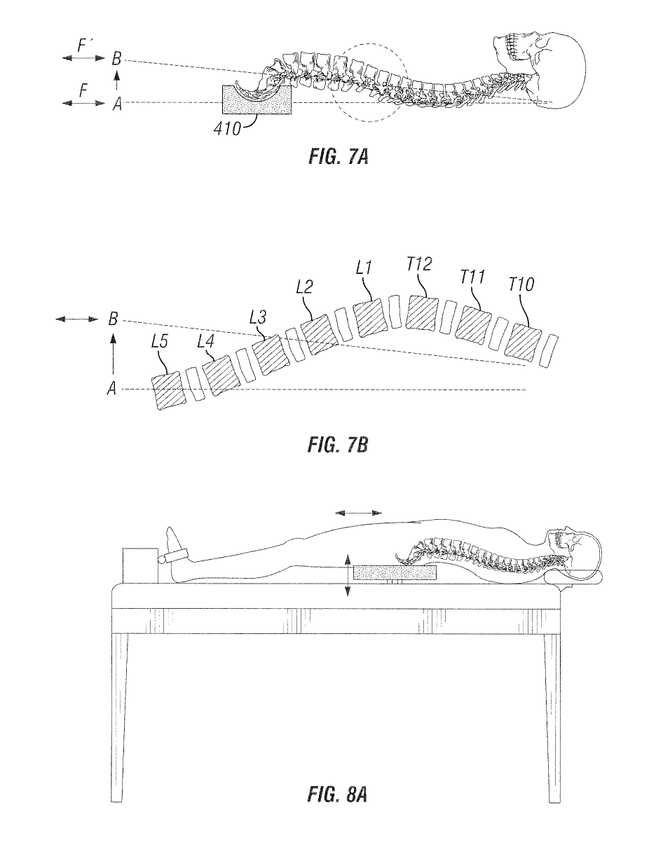

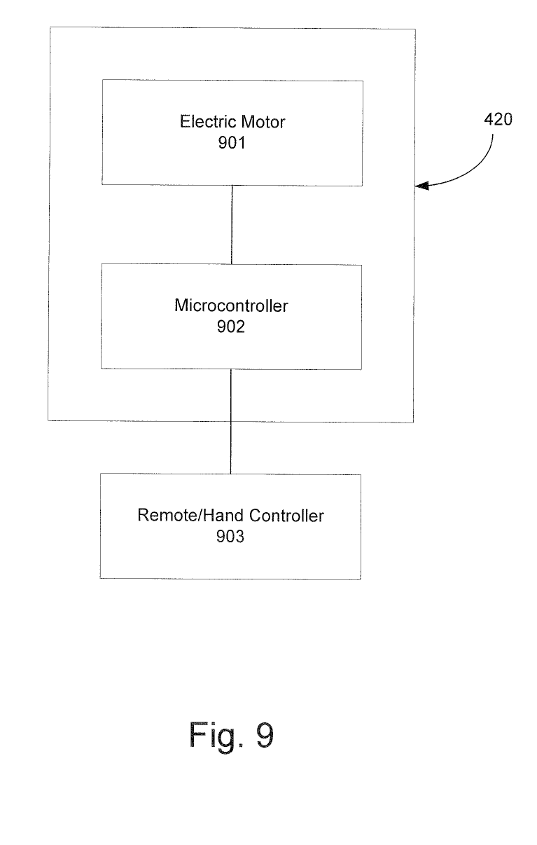

FIG. 6 depicts a close-up detailed view of the reciprocating motion device 420. The reciprocating motion device 420 moves in a back and forth motion to constantly compress and elongate either the upper or lower torso, in accordance with the specific embodiment chosen by a user as depicted in FIG. 8. FIG. 9 generally illustrates the manner in which the reciprocating motion device 420 is controlled. The motion device contains an electric motor 901 to provide for the oscillating motion of the device 420. As is known in the art, a microcontroller 902 connects to the electric motor 901 such that, in an optional embodiment, a remote or hand controller 903 will control the reciprocating motion device 420 via transmitted signals.

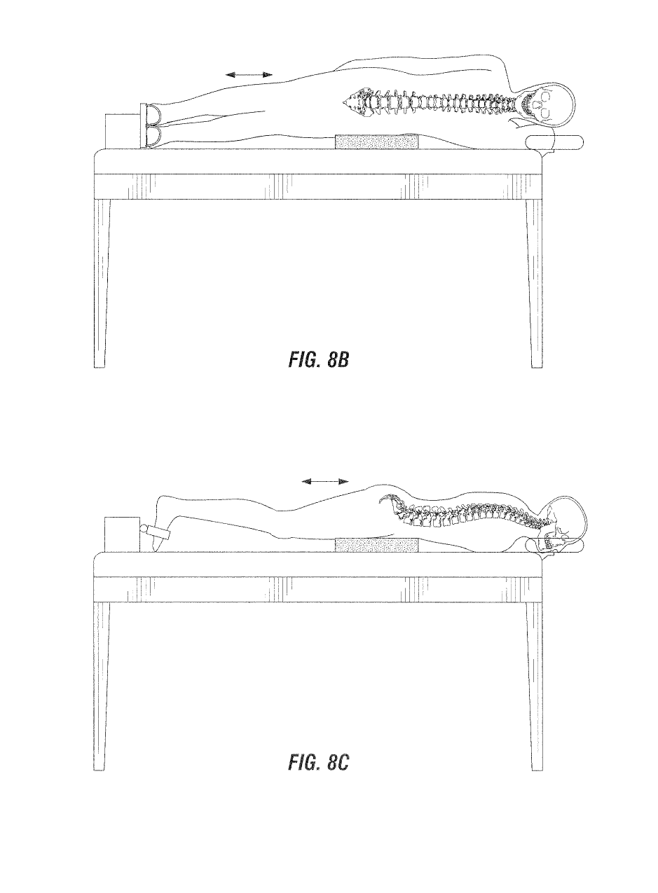

Referring now to FIG. 7, when the positioning pad 410 is adjusted vertically, the force created by the reciprocator 420 will result along different planes, A or B, for example. The natural curvatures of the spine will allow for different vertebrae to be focused upon by the continuous compression and elongation of the reciprocating motion device 420 as the pad is adjusted. In FIG. 7A, the force F, for example, is in a first plane A, as indicated by the dashed lines and which is substantially planar in its initial position. The motion of the reciprocating motion device 420 along this plane is able to target the fourth (L4) and fifth lumbar vertebra (L5) (shown in FIG. 7B), along with mid-portions of the thoracic region (T3-T6) (thoracic region not shown). By adjusting the seat to an elevated position B, creating a force F′, the reciprocating motion device 420 is able to provide targeted effects to other parts of the vertebrae, such as the lumbar vertebrae higher up along the spine (L1-L3) or the thoracic vertebrae (T7-T9). Adjusting the height by any amount will allow for other vertebrae to be targeted, allowing positive effects to specific parts of the spine and its interconnected muscles, nerves, and lymph nodes, while releasing tension in any specific area needed. In addition, adjusting the speed to a suitable reduced speed can provide slow, but positive, effects to any areas of the back that are tender as a result of any injuries sustained.

It should be noted that the user is not limited to facing any one direction. FIG. 8 describes some of the placement variations possible for the device. In FIG. 8a, the user lies face-up on his or her back with his pelvis in place on the adjustable positioning pad 410. However, in this preferred embodiment, a user places his feet within the stirrups attached to the reciprocating motion device 420. This, in turn, allows the user to feel more positive effects down the spine and legs. FIG. 8b illustrates another embodiment wherein a user lies on his or her side for those who may experience coccydynia, or tailbone pain, which comes from sitting, or other ailment wherein pressure along the pelvis should be avoided. FIG. 8c depicts a user lying face down to allow the motion of the reciprocating motion device 420 to target other vertebrae of the spine. In a final embodiment, depicted in FIG. 8d, a user lies face up but faces the opposite direction, holding onto the handles of the reciprocating motion device with his hands rather than feet. This allows for more focus and relaxation to the upper body consisting of the arms, torso and neck.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A spinal manipulation apparatus comprising:
(a) a table for holding a patient;
(b) a positioning pad for use under a patient's pelvis; and
(c) a reciprocating motion device for applying a translational force to a patient's spine;
wherein the force is in a first plane wherein the pad allows the spine to be positioned in a substantially planar position.

2. The apparatus of claim 1, wherein the positioning pad comprises a mechanism that allows for adjustment of the pad horizontally along the length of the table.

3. The apparatus of claim 1, wherein the positioning pad comprises a mechanism that allows for adjustment of the pad vertically.

4. The apparatus of claim 1, wherein the reciprocating motion device moves forward and backward approximately ¾ of an inch to 1½ inches, at a rate of at least three times per second to decompress the spine.

5. The apparatus of claim 1 wherein the reciprocating motion device comprises grasping means for a patient's hands.

6. The apparatus of claim 1, wherein the reciprocating motion device comprises grasping means for a patient's feet.

7. The apparatus of claim 1, wherein a remote control is attached to said reciprocating device such that a patient can control the speed and timing of said reciprocating motion.
